(19) United States
(12) Patent Application Publication
(10) Pub. No.: US 2010/0032278 A1
(43) Pub. Date: Feb. 11, 2010

(54) High-current circuit breaker

(75) Inventor: Ching-Ching Lin, Chung-Ho City (TW)

Correspondence Address: COOPER & DUNHAM, LLP, 30 Rockefeller Plaza, 20th Floor, NEW YORK, NY, 10112, US

(73) Assignee: Che Yen Industrial Co., Ltd.

(21) Appl. No.: 12/221,708

(22) Filed: Aug. 6, 2008

(51) Int. Cl. H01H 19/14

(52) U.S. Cl. 200/564

(57) ABSTRACT

A high-current circuit breaker has a base with a chamber, a contact on a bottom of the chamber, a conductive sheet, a supplement conductive sheet, a connecting element connecting the conductive sheet and the supplement conductive sheet, a rotational shaft and a spring. The conductive sheet is mounted in the chamber and is bendable to selectively contact the contact. The supplement conductive sheet is mounted on and contacts the conductive sheet and has a bending portion being formed in the supplement conductive sheet near a rear of the chamber and having multiple through holes. The rotational shaft is mounted in the chamber and has a stop protruding from the rotational shaft and being selectively located between the contact and the conductive sheet. The spring connects the rotational shaft and one side of the chamber. The supplement conductive sheet allows increased electricity current to pass through the high-current circuit breaker.

### BACKGROUND OF THE INVENTION

1. Field of Invention

The present invention relates to a circuit breaker, and more particularly to a circuit breaker that is used in an electronic device with high current and can be produced with low cost.

2. Description of the Related Art

An electronic device usually comprises a circuit breaker to prevent the electronic device from being damaged when electric current is over-large and the electronic device is overloaded.

A conventional circuit breaker has a case. The case has a base and a cover. The base has a chamber, a contact and a conductive sheet. The contact is mounted in the chamber. The conductive sheet is mounted in the base and selectively contacts the conductive sheet.

When the electronic device is used in normal operation, the conductive sheet contacts the contact to allow electric current of the electronic device to pass successfully through the circuit breaker. When the electric current is increased and makes the electronic device almost overloaded, heat will be generated, which the conductive sheet cannot bear, so that the conductive sheet will bend to depart from the contact. Therefore, the electronic device has a broken circuit to prevent the electronic device from being damaged.

As improvement of electronic devices, an electronic device has high current that the conventional circuit breaker cannot bear. Therefore, the conventional circuit breaker may have an enlarged conductive sheet, have a conductive sheet with an increased thickness or change material of the conductive sheet.

However, if the conventional circuit breaker has the enlarged conductive sheet, a structure of the conventional circuit breaker has to be changed. Furthermore, the electronic device is desired to have decreased size, so to enlarge the conductive sheet is not a good choice.

If the conventional circuit breaker has a conductive sheet with an increased thickness, the conductive sheet is not easy to be deformed. Therefore, the conductive sheet is hard to be detached from the contact, which cannot allow the circuit breaker to be regularly used.

Moreover, the conductive sheet is made of metal, such as silver, copper, gold, aluminum or the like, wherein copper or aluminum has low cost and is used in the conventional circuit breaker and silver has a best conductivity. If the conventional circuit breaker has a conductive sheet with different materials, only silver or an alloy containing silver or gold can be chosen, but both silver and gold have high cost. Therefore, the conventional circuit breaker that has a conductive sheet with different materials has an increased cost.

To overcome the shortcomings, the present invention provides high-current circuit breaker to mitigate or obviate the aforementioned.

### SUMMARY OF THE INVENTION

The primary objective of the present invention is to provide a high-current circuit breaker that is used in an electronic device with high current and can be produced with low cost.

To achieve the objective, the high-current circuit breaker in accordance with the present invention comprises a base with a chamber, a contact, a conductive sheet, a supplement conductive sheet, a connecting element, a rotational shaft and a spring. The contact is mounted on a bottom of the chamber. The conductive sheet is mounted in the chamber and is bendable to selectively contact the contact. The supplement conductive sheet is mounted on and contacts the conductive sheet and has a bending portion being formed in the supplement conductive sheet near a rear of the chamber and having multiple through holes. The connecting element connects the conductive sheet and the supplement conductive sheet. The rotational shaft is mounted in the chamber and has a stop protruding from the rotational shaft and being selectively located between the contact and the conductive sheet. The spring connects the rotational shaft and one side of the chamber.

The supplement conductive sheet allows increased electricity current to pass through the high-current circuit breaker. Because the supplement conductive sheet has the bending portion and multiple through holes, the supplement conductive sheet easily becomes deformed. Therefore, the supplement conductive sheet will not retard the conductive sheet to be deformed.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a high-current circuit breaker in accordance with the present invention;

FIG. 2 is a partially exploded perspective view of the high-current circuit breaker in FIG. 1 FIG. 3 is a side view in partial section of the high-current circuit breaker in FIG. 2;

FIG. 4 is a partially exploded perspective view of the high-current circuit breaker in FIG. 2; and

FIG. 5 is a perspective view of a supplement conductive sheet of the high-current circuit breaker in FIG. 2.

### DETAILED DESCRIPTION OF THE INVENTION

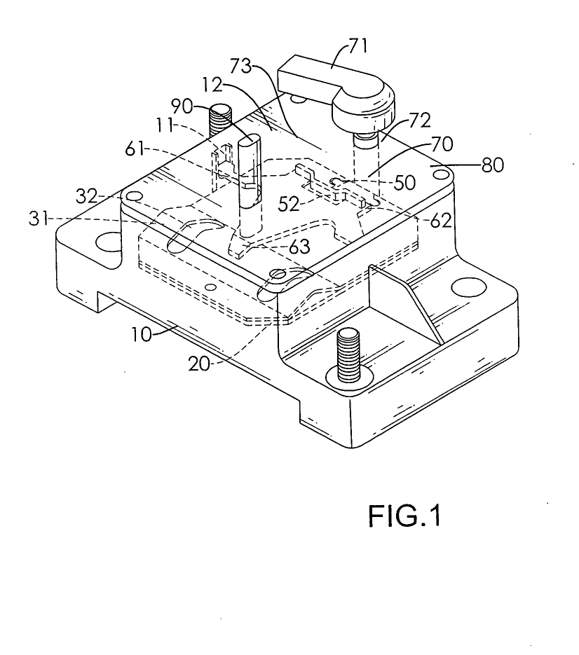

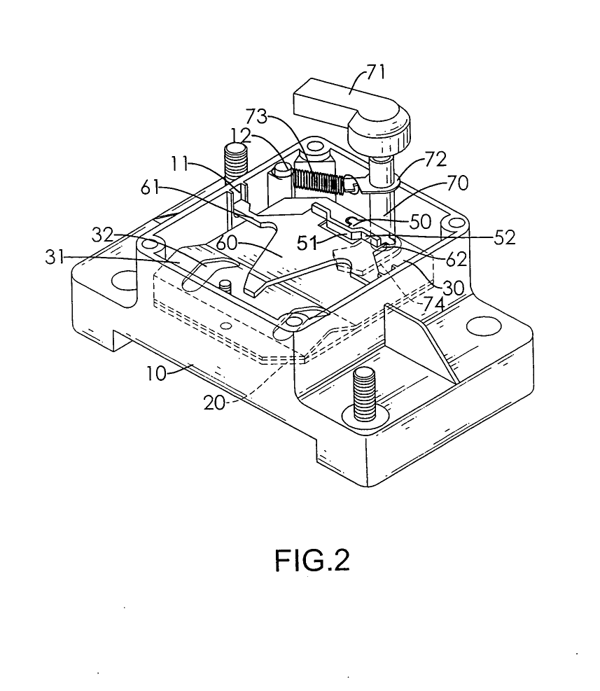

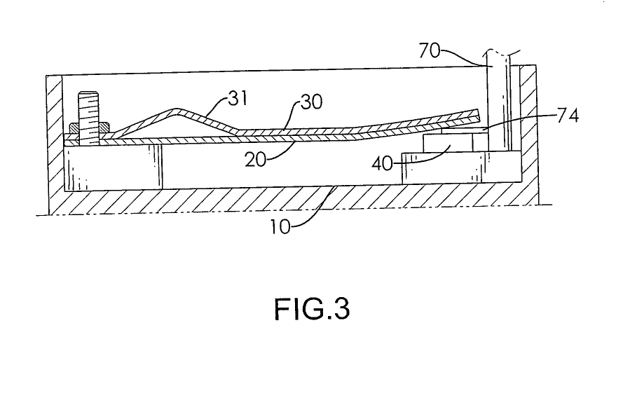

With reference to FIGS. 1 and 2, a high-current circuit breaker in accordance with the present invention has a case. The case has a cover (80) and a base (20). The base (10) has a chamber, a contact (40), a conductive sheet (20), a supplement conductive sheet (30), a connecting element (50), a pressing sheet (60), a rotational shaft (70), a spring (73) and a pressing shaft (90).

The chamber has a bottom, two sides, a front, a rear, two slots (11) and a protruding bar (12). The slots (11) are respectively formed in the sides of the chamber. The protruding bar (12) is mounted in the chamber between the front and one of the slots (11).

The contact (40) is mounted on the bottom near the front of the chamber.

The conductive sheet (20) is mounted in the chamber and is bendable according to temperature variation of the conductive sheet (20) to selectively contact the contact (40).

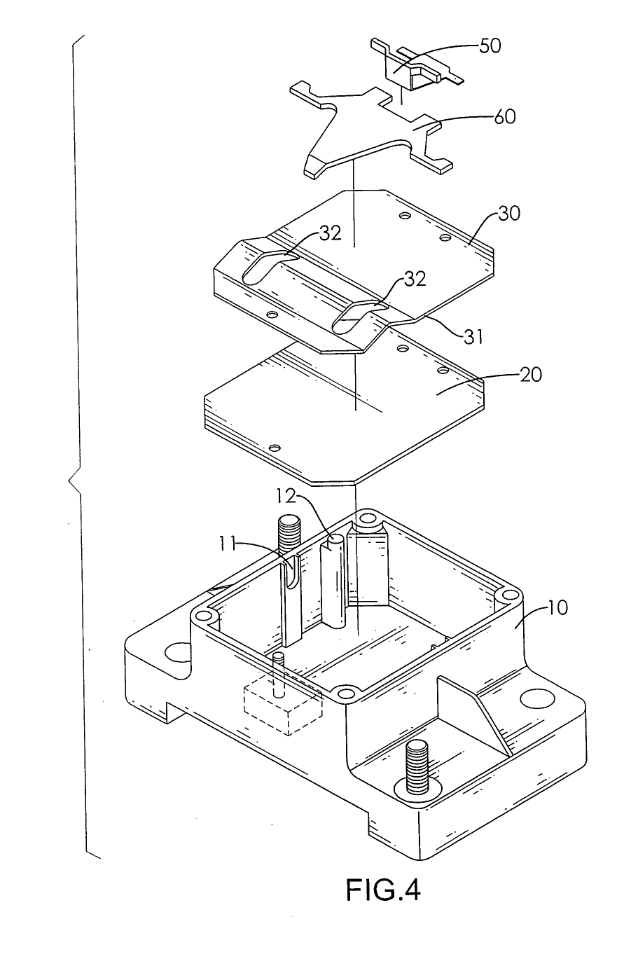

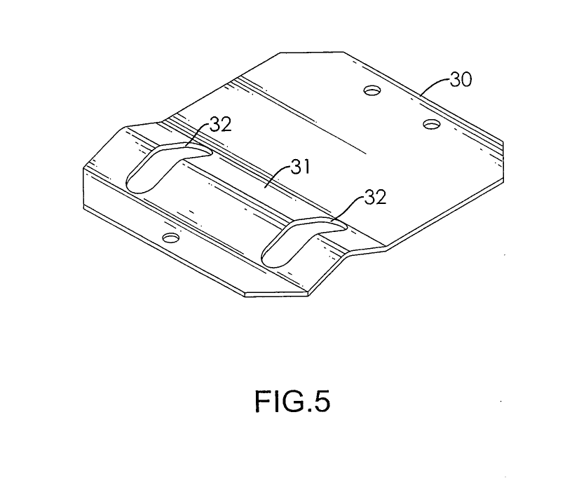

With further reference to FIGS. 3 to 5, the supplement conductive sheet (30) is mounted on and contacts the conductive sheet (20) and has a bending portion (31). The bending portion (31) is reversed-V-shaped, is formed in the supplement conductive sheet (30) near the rear of the chamber and has multiple through holes (32) and preferably has two through holes (32). The through holes (32) are symmetrically defined through the bending portion (31) of the supplement sheet (30).

The connecting element (50) is mounted in the chamber and hooks on the conductive sheet (20) is mounted near the front of the chamber, connects the conductive sheet (20) and the supplement conductive sheet (30) and has a central part (51) and two arms (52). The arms (52) protrude symmetrically from the central part (51).

The pressing sheet (60) is mounted pivotally in the chamber of the base (10) upon the supplement conductive sheet (30) and has a front, two sides, two wings (61) and two protrusions (62). The wings (61) respectively protrude from the sides of the pressing sheet (60) to the slots (11) in the sides of the chamber and allows the slots (11) to hold the wings (61). The protrusions (62) protrude from the front of the pressing sheet (60) and are respectively mounted between the supplement conductive sheet (30) and the arms (52) of the connecting element (50). The protrusions (62) may be lifted up to drive the arms (52) of the connecting element (50) to arise when the pressing sheet (60) is pressed, so the conductive sheet (20) and the supplement conductive sheet (30) are lifted up to allow the conductive sheet (20) to be detached from the contact (40).

The rotational shaft (70) is mounted on the front of the chamber and has an outside end, a lever (71), a stop (74) and a hook (72). The outside end extends out of the cover (80). The lever (71) is mounted securely on the outside end of the rotational shaft (70), is mounted above the cover (80) and allows an operator to switch the lever (71) to rotate the rotational shaft (70). The stop (74) protrudes from the rotational shaft (71) and is selectively located between the contact (40) and the conductive sheet (20) to electrically isolate the contact (40) from the conductive sheet (20). The hook (72) is formed on the rotational shaft (70) between the lever (71) and the stop (74).

The spring (73) connects the hook (72) and the protruding bar (12) in the chamber.

The pressing shaft (90) has a proximal end and a distal end. The proximal end contacts the pressing sheet (60). The distal end extends out of the cover (80) and allows the operator to press the pressing shaft (90).

When the electronic device is used in normal operation, the conductive sheet (20) contacts the contact (40) and the stop (74) is mounted in the front of the chamber and near the side opposite to side with the protruding bar (12), so the spring (73) is extended. Electricity current passes successfully through the high-current circuit breaker. The electricity current can pass through the conductive sheet (20) and the supplement conductive sheet (30). Therefore, the electricity current can bear a high electricity current.

When the electricity current is increased and is larger than an electricity current that the high-current circuit breaker can bear, the conductive sheet (20) and the supplement conductive sheet (30) will both be bent because of heat to allow the conductive sheet (20) to be detached from the contact (40). Simultaneously, the spring (73) pulls the hook (72) to make the rotatable shaft (72) rotate, so the stop (74) will move to a location between the contact (40) and the conductive sheet (20) to ensure the conductive sheet (20) to separate from the contact (40).

Because the supplement conductive sheet (30) has the bending portion (31) and multiple through holes (32), the supplement conductive sheet (30) is deformed easily. Therefore, the supplement conductive sheet (30) will not retard the deformation of the conductive sheet (20).

Furthermore, an operator can test the high-current circuit breaker of the present invention before it is sold to ensure that the stop can move to the location between the contact (40) and the conductive sheet (20). During testing the high-current circuit breaker, the operator presses the pressing shaft (90) and the proximal end presses the pressing sheet (60) to make the pressing sheet (60) rotate along the wings (61) that serves as pivoting axes. Therefore, the protrusions (62) of the pressing sheet (60) raise the arms (52) of the connecting element (50), also make the supplement conductive sheet (30) and the conductive sheet (20) to be bent and allow the conductive sheet (20) to be detached from the contact (40). After testing, the operator switches the lever (71) to rotate the rotational shaft (70) and to allow the stop (74) to leave the location between the contact (40) and the conductive sheet (20), so the conductive sheet (20) contacts the contact (40) again.

Consequently, if the stop (74) moves to the location between the contact (40) and the conductive sheet (20), this high-current circuit breaker is a regular product that can be sold. If the stop (74) cannot move to the location between the contact (40) and the conductive sheet (20), this high-current circuit breaker has to be checked and fixed. Accordingly, the present invention can be tested easily.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A high-current circuit breaker comprising a base that has:
a chamber having
a bottom;
two sides;
a front;
a rear;
a contact being mounted on the bottom near the front of the chamber;
a conductive sheet being mounted in the chamber and being bendable to selectively contact the contact;
a supplement conductive sheet being mounted on and contacting the conductive sheet and having a bending portion being formed in the supplement conductive sheet near the rear of the chamber and having multiple through holes;
a connecting element being mounted near the front of the chamber and connecting the conductive sheet and the supplement conductive sheet;
a rotational shaft being mounted on the front of the chamber and having
a lever being formed on an outside end of the rotational shaft; and
a stop protruding from the rotational shaft and being selectively located between the contact and the conductive sheet to electrically isolate the contact from the conductive sheet; and
a spring connecting the rotational shaft and one side of the chamber.

2. The high-current circuit breaker as claimed in claim 1, wherein the bending portion of the supplement conductive sheet is reversed-V-shaped and the supplement conductive sheet has two through holes that are symmetrically defined through the bending portion of the supplement sheet.

3. The high-current circuit breaker as claimed in claim 2, wherein
the chamber further has a protruding bar being mounted in the chamber near one of the sides;
the rotational shaft further has a hook being formed on the rotational shaft between the lever and the stop; and
the spring connects the protruding bar and the hook.

4. The high-current circuit breaker as claimed in claim 1, wherein
the chamber has two slots being respectively formed in the sides of the chamber;
the connecting element has
a central part; and
two arms protruding symmetrically from the central part; and
the high-current circuit breaker further has
a pressing sheet being mounted pivotally in the chamber of the base upon the supplement conductive sheet and having
a front;
two sides;
two wings respectively protruding from the sides of the pressing sheet to the slots in the sides of the chamber and allowing the slots to hold the wings; and
two protrusions protruding from the front of the pressing sheet and being respectively mounted between the supplement conductive sheet and the arms of the connecting element; and
a pressing shaft having a proximal end contacting the pressing sheet.

5. The high-current circuit breaker as claimed in claim 2, wherein
the chamber has two slots being respectively formed in the sides of the chamber;
the connecting element has
a central part; and
two arms protruding symmetrically from the central part; and
the high-current circuit breaker further has
a pressing sheet being mounted upon the supplement conductive sheet and having
a front;
two sides;
two wings respectively protruding from the sides of the pressing sheet to the slots in the sides of the chamber and allowing the slots to hold the wings; and
two protrusions protruding from the front of the pressing sheet and being respectively mounted between the supplement conductive sheet and the arms of the connecting element; and
a pressing shaft having a proximal end contacting the pressing sheet.

6. The high-current circuit breaker as claimed in claim 3, wherein
the chamber has two slots being respectively formed in the sides of the chamber;
the connecting element has
a central part; and
two arms protruding symmetrically from the central part; and
the high-current circuit breaker further has
a pressing sheet being mounted upon the supplement conductive sheet and having
a front;
two sides;
two wings respectively protruding from the sides of the pressing sheet to the slots in the sides of the chamber and allowing the slots to hold the wings; and
two protrusions protruding from the front of the pressing sheet and being respectively mounted between the supplement conductive sheet and the arms of the connecting element; and
a pressing shaft having a proximal end contacting the pressing sheet.

7. The high-current circuit breaker as claimed in claim 1, further having a cover to cover the base, wherein the outside end of the rotational shaft extends out of the cover and the lever is mounted above the cover.

8. The high-current circuit breaker as claimed in claim 2, further having a cover to cover the base, wherein the outside end of the rotational shaft extends out of the cover and the lever is mounted above the cover.

9. The high-current circuit breaker as claimed in claim 3, further having a cover to cover the base, wherein the outside end of the rotational shaft extends out of the cover and the lever is mounted above the cover.

10. The high-current circuit breaker as claimed in claim 4, further having a cover to cover the base, wherein the outside end of the rotational shaft extends out of the cover and the lever is mounted above the cover.

11. The high-current circuit breaker as claimed in claim 5, further having a cover to cover the base, wherein the outside end of the rotational shaft extends out of the cover and the lever is mounted above the cover.

12. The high-current circuit breaker as claimed in claim 6, further having a cover to cover the base, wherein the outside end of the rotational shaft extends out of the cover and the lever is mounted above the cover.

13. The high-current circuit breaker as claimed in claim 4, further having a cover to cover the base, wherein the pressing shaft further has a distal end extending out of the cover.

14. The high-current circuit breaker as claimed in claim 5, further having a cover to cover the base, wherein the pressing shaft further has a distal end extending out of the cover.

15. The high-current circuit breaker as claimed in claim 6, further having a cover to cover the base, wherein the pressing shaft further has a distal end extending out of the cover.
